(19) United States
(12) Patent Application Publication
(10) Pub. No.: US 2025/0218633 A1
(43) Pub. Date: Jul. 3, 2025

(54) MAGNETIC CHAMBER AND MODULAR COILS

(71) Applicant: Renaissance Fusion, FONTAINE (FR)

(72) Inventor: Francesco VOLPE, FONTAINE (FR)

(21) Appl. No.: 18/850,399

(22) PCT Filed: Mar. 31, 2023
(86) PCT No.: PCT/EP2023/058468

§ 371 Date: Sep. 24, 2024

(30) Foreign Application Priority Data
Apr. 4, 2022 (EP) 22305437.0
Apr. 4, 2022 (EP) 22305444.6

(51) Int. Cl. H01F 6/06; G21B 1/05; H01F 5/04; H01F 6/04

(52) U.S. Cl. CPC H01F 6/06; H01F 5/04; H01F 6/04; G21B 1/055

(57) ABSTRACT

The present disclosure relates to an assembly comprising a plurality of modular coils (100a, 100b; 401) mechanically and electrically joined together, wherein each modular coil comprises a groove (110a, 110b) separating the modular coil into at least two different electrically conducting regions.

This application is based on and claims the priority benefit of European patent application number 22305444, filed on Apr. 4, 2022, entitled “MAGNETIC CHAMBER AND MODULAR COILS,” and of European patent application number 22305437, filed on Apr. 4, 2022, entitled “METHOD FOR MANUFACTURING SUPERCONDUCTING COILS AND DEVICE” which are hereby incorporated by reference to the maximum extent allowable by law.

### TECHNICAL FIELD

The present disclosure is related to magnetic chambers, particularly it is related to magnetic chambers with coils constructed modularly.

### BACKGROUND ART

The marvels of the modern world are owed mostly to the development of devices that employ in one way or another magnetic fields. Yet, there are applications of magnetic fields that are still unattainable due to limitations in the construction methods of magnetic devices and magnetic confinement chambers.

A magnetic chamber is a closed volume in which a magnetic field is sustained. Magnetic fields may be created from current flows and exist in nature in permanent magnets. Magnetic fields affect many objects in nature depending on the material the object is made of, materials that are affected by magnetic fields are known as magnetic materials. In order for a magnetic field to be useful in a certain application, it is usually required that the field have a certain configuration, usually denoted by field lines. Field lines represent the way other magnets would align themselves under the effect of the field. Field lines extend throughout space. Magnetic fields also describe other characteristics like magnetic field intensity.

A magnetic chamber having a specific magnetic field configuration inside is useful in many applications. In magnetic resonance imaging MRI applications, a highly uniform magnetic field is required. In contrast, in fusion energy applications, like those involving stellarators, a twisting and complex magnetic field is required. In many applications, the magnetic field also needs to change in time, in the sense that some of its characteristics need to be modified. Magnetic field applications for transportation, like magnetic levitation trains or hyperloops usually require that the magnetic field move in order to cause the movement of the train. Magnetic fields, and therefore magnetic chambers that contain them, also have applications in the food industry where they are used to effect mixing or separation. Other applications include the electricity industry, especially electrical energy transmission, where magnetic fields are used to measure electric current intensity.

Some applications of magnetic chambers are further benefitted if the magnetic field can be confined to the inside of the container, which is called the vessel. A natural phenomenon known as the Meissner effect describes that magnetic fields are expelled from a superconductor. A superconductor is a material in which electric current may flow without any resistance; thus, a superconductor is an ideal conductor because current flows without energy losses. These two properties of superconductors are very attractive to manufacturers and designers of magnetic devices, they can be used as the conductor for the current and a magnetic chamber can be lined with one to confine the magnetic field inside.

Presently, magnetic chambers are constructed with large magnets that are shaped into the form of a coil; magnets may be either permanent or electrical depending on cost or application. In applications where the field needs a special configuration, for instance, in stellarators, the coil must be twisted to a complicated shape during construction. This greatly increases costs during the design and manufacturing phases; stellarator design is very complicated and requires a lot of testing, so constructing many magnets coils requires a lot of time and of money.

A magnetic module for MRI machines is described in U.S. Pat. No. 8,838,193 to Maher et al. The module described by Maher is constructed by adding a conducting surface path of a superconducting material onto a supporting structure. The path is described as conical or preferably a spiral. Several modules, each sized at about 1 m², are aligned to produce the magnetic field that an MRI require. As described by Maher, the modules only work in tandem with each other, so a magnetic field is created from the combination of the effect of the modules. Also, according to Maher, each module produces a specific magnetic field configuration. Maher describes the way modules may be arranged together to produce a magnetic field, but he does not describe or disclose a method by which the modules may be used to contain or confine a magnetic field. A careful reading of Maher's description of the modules reveals that it is impossible to confine the magnetic field using the described module arrangement because each module must produce a magnetic field in a specific direction in order to work in tandem with the others. Further, many modules may be required to generate a specific magnetic field configuration, and more complex configurations become harder to develop as the number of modules increases. The description of the modules operation which requires every module to be housed in different orientations and positions makes them unsuitable as vessel components. Maher fails to disclose a way in which the modules may be used in applications that required magnetic confinement, to construct specific vessel shapes or a way in which such modules may be used to produce complex magnetic fields without needing an impractical number of modules.

With respect to the coils, the prior art teaches several methods for constructing one, for instance the superconducting coil described in U.S. Pat. No. 8,655,423 to Miyazaki, et al. Miyazaki describes a superconducting coil formed of several layers of different materials. A group of these layers is described as constituting a superconducting coil portion which is formed of thin-film superconducting wires. The coils described by Miyazaki and those that are common in the art are constructed by arranging superconducting films, also called superconducting tapes, into the shape of wires and the wires are then further configured into the shape of coils. According to a review of the prior art, superconducting coils are formed by stacking superconducting films or layers so that electric current may flow in a desired direction and produce the appropriate magnetic field configuration. To the best knowledge and understanding of the inventors, the prior art doesn't teach any other method by which the superconducting films or tapes may be used to conduct a current.

Superconducting tapes themselves are also in short supply, as their demand is high. There is also the problem of the size and shape of the tapes which can only be constructed a few centimeters wide. In addition, the process that arranges the tapes into wires and further into coils is lengthy and error prone.

Thus, there remains a need for an efficient and less costly alternative to the coils that are used in magnetic applications, there remains a need for a magnetic chamber that can confine a magnetic field inside it. There is a need for the magnetic chamber to be of any possible configuration or shape and to produce, irrespective of the shape, an arbitrary magnetic field configuration. Fundamentally, there is a need for a magnetic chamber that can be constructed with a little number of parts and that can be manufactured at a better cost. Also, there is a need for the magnetic chamber to be simply constructed in a manner that allows replication and quick modification of the confined magnetic field.

### SUMMARY OF INVENTION

One embodiment addresses all or some of the drawbacks of known magnetic modules and chambers.

One embodiment provides an assembly comprising a plurality of modular coils mechanically and electrically joined together, wherein each modular coil comprises a groove separating the modular coil into at least two different electrically conducting regions.

In one embodiment, the plurality of modular coils comprises at least a first modular coil having a first groove and a second modular coil joined to the first modular coil and having a second groove, wherein the first and second grooves are adapted to form a continuing groove separating the joined first and second modular coils into at least two different electrically conducting regions.

In one embodiment, the grooves are adapted to guide a flow of current in a certain direction through the joined modular coils, in order to create a magnetic field that is at least partially confined in the assembly.

In one embodiment, the shape of the groove of at least one of the modular coils determines the electrical current configuration to pass through said modular coil, and therefore, the shape of the magnetic field that is formed when the current flows.

In one embodiment, the groove of at least one of the modular coils contains a metal, for example silver.

In one embodiment, the plurality of modular coils comprises a first modular coil having a first joining mechanism, like a flange, and a second modular coil having a second joining mechanism, like a flange, adapted to be coupled, preferably connected, to the first joining mechanism.

In one particular embodiment, each joining mechanism is also adapted to provide for electrical connection between the first and second modular coils.

In one embodiment, at least one of the modular coils comprises a channel, for example to enable a cooling fluid, like nitrogen or helium, to flow through said modular coil.

In one particular embodiment, the plurality of modular coils comprises a first modular coil having a first channel and a second modular coil joined to the first modular coil and having a second channel adapted to be joined to the first channel to form a single channel that crosses the joined first and second modular coils.

In one embodiment, at least one of the modular coils is constructed to exhibit superconducting characteristics.

In one embodiment, at least one of the modular coils is constructed as a stacking of different materials, comprising at least a superconducting layer comprising a superconducting material, like yttrium barium copper oxide or rare-earth barium copper oxide, wherein the groove of said modular coil is patterned at least in the superconducting layer.

In one embodiment, the stacking comprises:
a structural layer, for example composed or covered by a material like Hastelloy;
a plurality of buffer layers on the structural layer;
the superconducting layer on the plurality of buffer layers; wherein the groove is patterned in the buffer layers and the superconducting layer.

In one embodiment, the stacking comprises a silver layer on the superconducting layer.

In one embodiment, the stacking comprises:
a structural layer, for example composed or covered by a material like Hastelloy;
a plurality of buffer layers on the structural layer;
the superconducting layer on the plurality of buffer layers; and
a shunt layer on the superconducting layer and in the groove, the shunt layer being made of a metal, for example silver; wherein the groove is patterned in the buffer layers and the superconducting layer.

In one embodiment, the stacking comprises a repeater layer under the shunt layer, the repeater layer being made of the repetition of the buffer and superconducting layers, and in some cases of the silver layer, preferably several repetitions, for example between 4 and 80 repetitions, wherein the groove is patterned in the buffer layers, the superconducting layer and the repeater layer.

In one embodiment, the stacking comprises another superconducting layer, preferably a non-perforated and non-grooved layer, on the shunt layer, the other superconducting layer comprising for example a superconducting material like yttrium barium copper oxide or rare-earth barium copper oxide.

In one particular embodiment, the channel of the at least one modular coil goes through the structural layer.

In one embodiment, at least one of the modular coils comprises a first portion and a second portion, the first and second portions being adapted to be coupled together, for example the first portion comprising a connecting seam and the second portion comprising a receiving cavity adapted to engage the connecting seam.

In one embodiment, at least one of the modular coils, and for example each of the first and second portions of said modular coil, is formed of at least two walls assembled together, for example two or three walls.

In one embodiment, the modular coils form a magnetic chamber.

One embodiment provides a modular coil adapted to an assembly according to an embodiment.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1A is a general perspective view of two modular coils in a first embodiment.

FIG. 1B is a perspective view of the two modular coils in the first embodiment in a joined configuration.

FIG. 1C is an exploded view of the two joined modular coils in the first embodiment separated through a middle line.

FIG. 2A is a general perspective view of a single modular coil with a specific groove according to the first embodiment.

FIG. 2B is a general perspective view of a single modular coil with a specific groove different from the one in FIG. 2A according to the first embodiment.

FIG. 3 is perspective view of the internal construction of the modular coil according to the first embodiment.

FIG. 4 is a perspective view of a magnetic chamber constructed of the modular coils according to the first embodiment.

FIG. 5 is a perspective view of the cross section of the interior of the magnetic chamber constructed of the modular coils according to the first embodiment.

FIG. 6A is a perspective view of two modules in a second embodiment.

FIG. 6B is a perspective view of two modules in the second embodiment in a joined configuration.

FIG. 6C is an exploded view of two joined modules in the second embodiment.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

The figures are not to scale. It should be noted that the drawings refer to an embodiment of the disclosed magnetic chamber and modular coils, sometimes also referred simply as device, when no ambiguity is anticipated. Other embodiments may be possible, as someone with appropriate training may readily appreciate. The actual dimension and/or shape of each of the components of the embodiment may vary. Only important details of the embodiment are shown, however one of ordinary skill in the art can appreciate how the overall device may be constructed, without undue experimentation. Some details have been omitted from the drawings, but the inventors believe that adding these details is unnecessary for the overall appreciation of the characteristics of the invention disclosed. These omitted details include, among others, elements for holding or fixing the device or its functional components. Some characteristics of the embodiment appear exaggerated to facilitate understanding. The embodiments disclosed, and alternatives observed should not be considered as limiting the invention in any way.

The magnetic chamber is composed of modular coils. These modular coils join together mechanically and electrically to transport current which creates the magnetic field that is confined in the magnetic chamber.

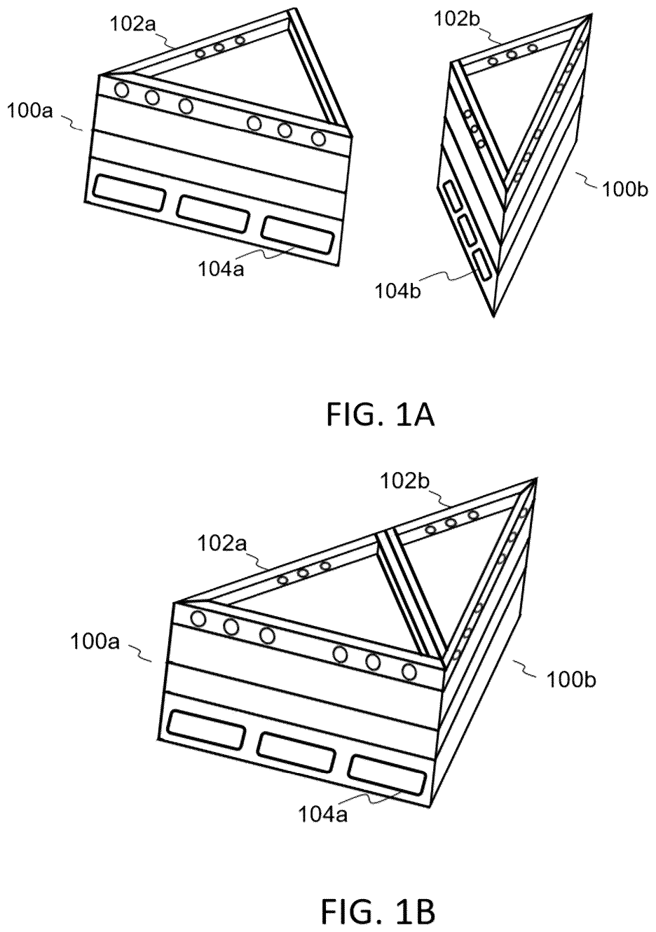

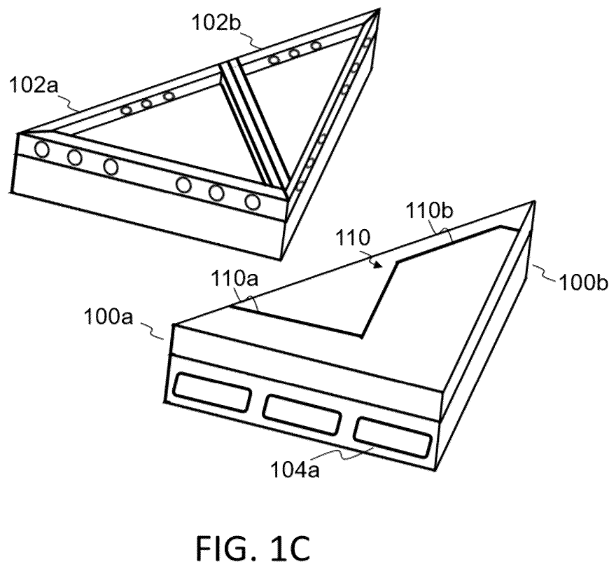

An embodiment of two of these modular coils is shown in FIG. 1A. A first modular coil 100a, has an interlocking, locking or joining mechanism like flanges 102a and a tunnel, canal, or channel 104a that crosses it. A second modular coil 100b, also has flanges 102b and a canal 104b.

When reference is made to a joining mechanism, this also includes an interlocking or a locking mechanism, and when reference is made to a channel, this also includes a tube, a tunnel or a canal.

The modular coils from FIG. 1A are joined together by mechanical means as shown in FIG. 1B. The flange 102a of the first modular coil 100a is joined to the flange 102b of the second modular coil 100b. At the flanges or through some other means, electrical connection may be furnished, so that electrical current may flow from one modular coil to the other. The channel 104a of the first modular coil 100a may also be joined to the channel 104b of the second modular coil 100b forming a single channel that crosses both structures. Through the channel 104a and/or the channel 104b a cooling fluid may be made to flow. Further, the joined modular coils shown in FIG. 1B may be joined to another such structure creating a larger structure. In another example, the channels of joined modular coils may not be connected, and other means may be provided to make a cooling fluid passing through the channel of each modular coil.

FIG. 1C shows the internal structure of the joined modular coils from FIG. 1B when they are separated through a plane parallel to the channel 104a. The internal structure includes a groove 110, that runs from the first modular coil 100a to the second modular coil 100b or vice-versa. The groove 110 (continuing groove) is formed by a first groove 110a of the first modular coil 100a connected continuously with a second groove 110b of the second modular coil 100b. The groove 110 divides the joined modular coils into different electrically conducting regions. Therefore, the groove 110 allows for different electrical current configurations to pass through the joined modular coils. The shape of the groove 110 ultimately decides the shape of the magnetic field that is formed when the current flows. In another example, the grooves of some of the joined modular coils may not be connected continuously. For example, in some configurations, each of the different conducting regions of a first modular coil may be connected with a corresponding conducting region of a second modular coil, without their grooves being connected together.

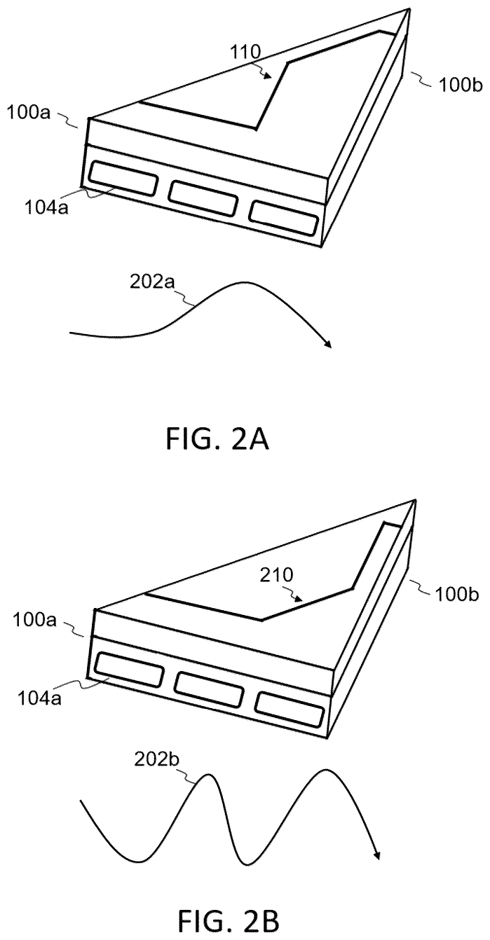

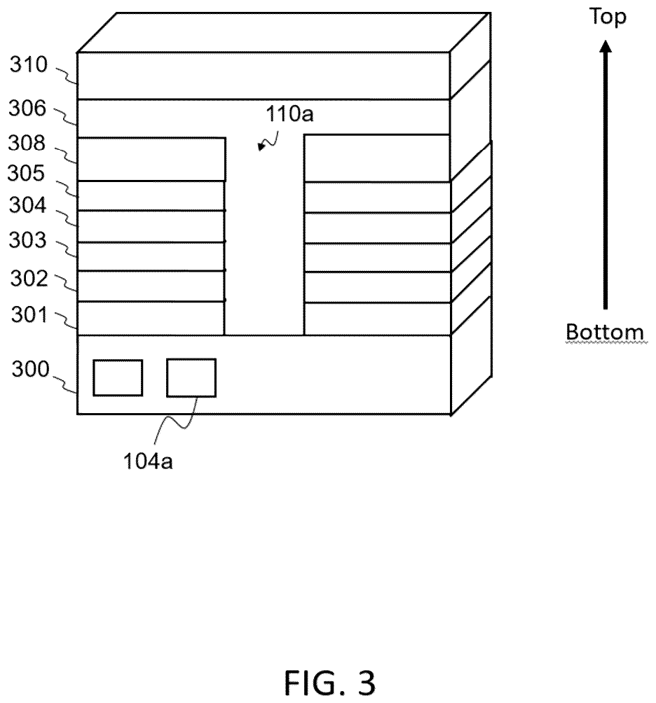

As shown in FIG. 2A, a specific groove 110 pattern results in a magnetic field with a certain configuration 202a. In FIG. 2B a different groove pattern 210 results in a different magnetic field configuration 202b. The actual magnetic field configuration will depend on the rest of the structure and the way the current flows through each of the modular coils.

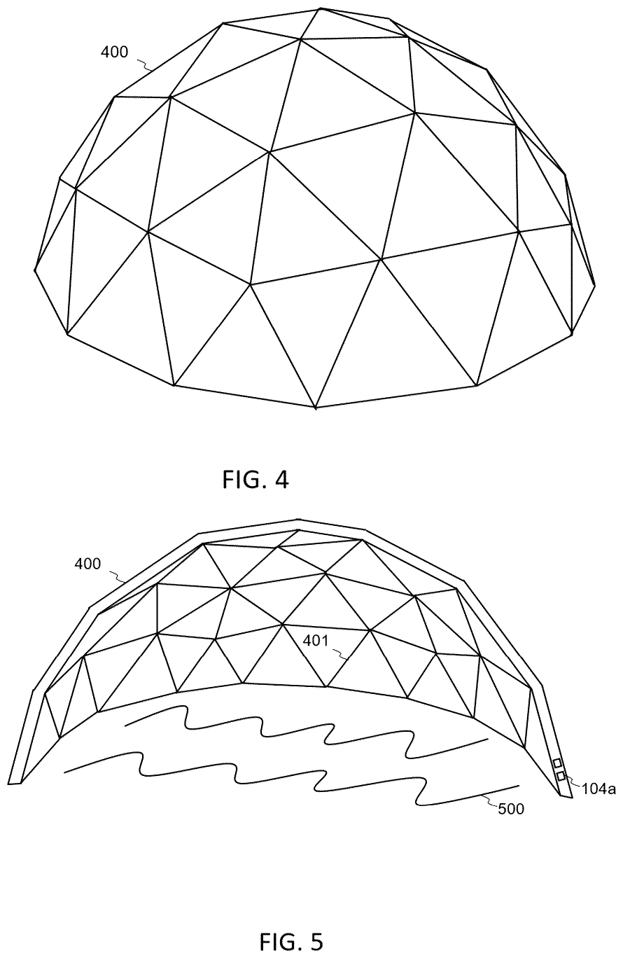

The modular coils in FIG. 1B may join other modular coils in a similar configuration, forming a larger structure that may be called an assembly. The assembly is a closed chamber that sustains a magnetic field; therefore, it comprises a magnetic chamber. The magnetic chamber may be of any shape, accommodating to the construction fashioned by the assembly. One such assembly is the dome 400 shown in FIG. 4. A cross sectional view of the dome 400 is shown in FIG. 5.

The dome 400 is assembled from a plurality of modular coils 401. The channels 104a cross the dome 400 through the outer wall of the dome. All the channels 104a of all the modular coils 401 may be connected together, forming a single channel that covers the whole dome 400, to ensure that any cooling fluid reaches every modular coil. In another example, as described above, the channels of the modular coils may not all be connected together.

### Example of Operation

An example of operation of the modular coils and the magnetic chamber can be explained with reference to FIG. 5. During operation, the modular coils 401 are energized, meaning that electrical current is flowing through them. The power to energize the coils 401 may come from an external power supply. As current flows through the coils 401, a magnetic field 500 is formed inside the dome 400. The shape, intensity, and configuration of the magnetic field 500 depends on the characteristics of the modular coils 401. The characteristics of the magnetic field 500 also depends on the shape of the magnetic chamber. Each modular coil 401 has a groove 110a as the one from FIG. 1C, which guides the flow of current. As shown in FIG. 2A and FIG. 2B different groove 110 patterns result in different shapes for the magnetic field 500.

The modular coils 401 may be constructed to exhibit superconducting characteristics, said characteristics can be used to exploit the Meisner effect and trap the magnetic field 500 inside the magnetic chamber.

Proper operation of the device may require that the modular coils 401 retain a certain temperature. The channels 104a that cross the inner walls of the modular coils 401 can be used to supply a cooling fluid. For example, if the modular coils 401 are to exhibit superconducting characteristics, fluids like nitrogen or helium can be made to flow through the channels 104a and ensure the superconducting characteristics of the modular coils 401.

### Example of Construction of the Modular Coils

The modular coil may be constructed as a stacked layer of different materials (stacking), for example as shown in FIG. 3. From the bottom, which may be closest to the side the magnetic field will be formed on, the stacking comprises a first structural layer 300, which may be composed or covered by a material like Hastelloy. The channels 104a for the cooling fluid may go through the first structural layer 300. Several buffer layers are deposited on top of the first structural layer 300. Sputtered on top of the first structural layer 300 is a layer of a material like alumina, called the first buffer layer 301. The second buffer layer 302 is sputtered on top of the first buffer layer 301. The second buffer layer 302 is composed of a material like yttria. The third buffer layer 303 is composed of a material like magnesium oxide and may be deposited by metal-organic chemical vapor deposition MOCVD or ion beam assisted deposition IBAD. A superconducting layer 304 is deposited on top of the third buffer layer 303. The superconducting layer 304 may be deposited by MOCVD and may be composed of a material like REBCO or YBCO or other appropriate superconducting materials. Material from the first buffer layer 301, the second buffer layer 302, the third buffer layer 303 and the superconducting layer 304 may be removed in order to create a pattern which describes the groove 110a that can also be seen in FIG. 1C. In order to remove the material, a technique like laser patterning may be used. Other techniques, like a mechanical technique or photolithography may be used to remove material.

Alternatively, it is possible to remove material only from the superconducting layer 304 to create the groove 110a.

The buffer layers may form an appropriate template for the formation of the superconducting layer. There may be only one buffer layer instead of a plurality of buffer layers.

Other appropriate materials may be used in place of the ones described here.

The groove 110a may be filled with a metal, which may be silver, forming a shunt layer 306 that may also be positioned above the superconducting layer 304. Such a shunt layer offers a path to current in case of quenching of the superconducting layer 304. The shunt layer 306 is optional. There are other solutions to address the quenching problem, such as operating at low enough current, temperature and/or magnetic field. Quenching is a problem for superconductivity in general, which is not linked to the problem addressed by the embodiments.

Before forming the groove, the described sequence of buffer and superconducting layers may be repeated several times, with best results being achieved between 4 and 80 repetitions of the layer sequence, for example between 20 and 40 repetitions of the layer sequence for magnetic fields of about 10 Tesla. In FIG. 3, this is indicated by the repeater layer 308, in which the groove 110a is also formed, and the shunt layer 306 is deposited after the groove is formed, so that the shunt layer 306 fills the groove 110a and covers the superconducting layer of the last sequence.

The repeated layer sequence may comprise a silver layer 305 on the superconducting layer 304 or a layer of another material which is appropriate for the formation of another sequence of buffer and superconducting layers on said sequence.

For example, the depth of the groove 110a is comprised between 3 and 5 μm for one sequence of buffer and superconducting layers. If the sequence is repeated, the depth of the groove may be multiplied by the number of sequences. For example, the depth of the groove is comprised between 3×N and 5×N μm, where N is the number of sequences.

To make at least partially use of the Meisner effect, on top of all the described layers, for example on top of the shunt layer 306, a single, preferably non-perforated (and not-grooved), layer of superconducting material should be placed. This layer is the Meisner effect layer 310 and is composed of a superconducting material like YBCO or REBCO.

Layers of other materials either above or below the ones described may be required for the proper operation of the device, nevertheless it should be apparent to anyone with ordinary skill in the art how to achieve the functionality described here with a different layer configuration. As an example of this, stabilizing layers composed of silver, copper and other metals may be placed below the first structural layer 300.

Other layer configurations and/or methods for constructing a modular coil as a stacked layer of different materials should be apparent to anyone with ordinary skill in the art. Another example of a method or a coil is given in European patent application number EP22305437, filed on Apr. 4, 2022 by the same applicant “RENAISSANCE FUSION”, entitled “METHOD FOR MANUFACTURING SUPERCONDUCTING COILS AND DEVICE”, which is hereby incorporated by reference to the maximum extent allowable by law.

### Additional Embodiments

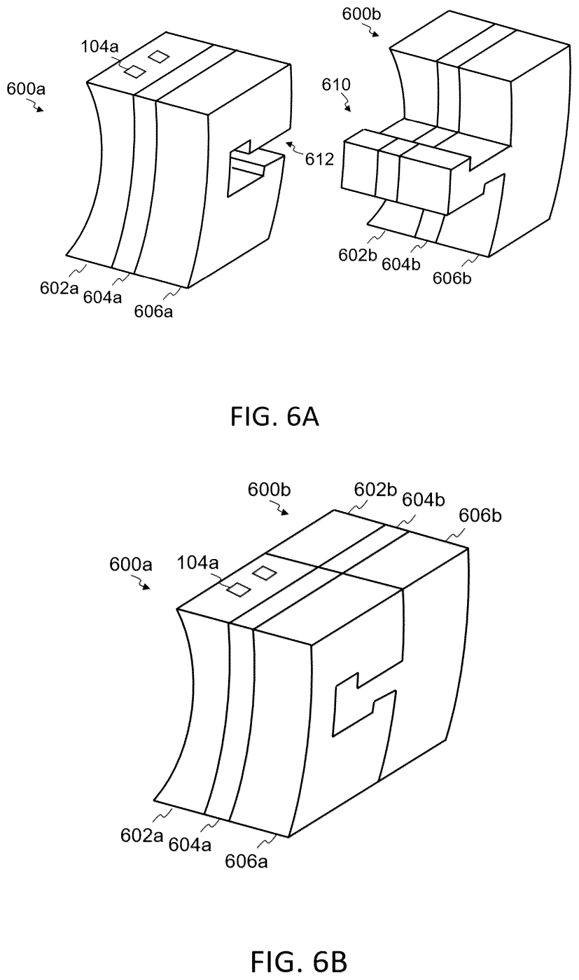

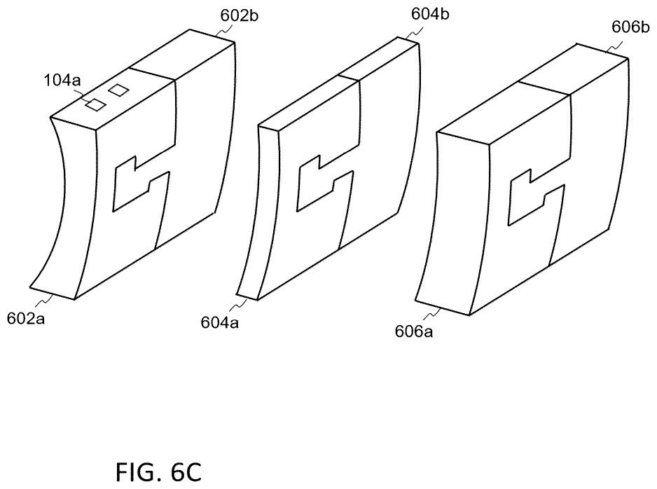

A second embodiment of the modular coils is shown in FIG. 6A. In the second embodiment, a modular coil is formed of six parts that are connected together by means of a connecting seam 610 and a receiving cavity 612, joining together like a puzzle piece. The modular coil having such a receiving portion 600a (first portion) and a connecting portion 600b (second portion) adapted to cooperate together, by the way of a puzzle or any other assembling means, allow forming assemblies of different and specific forms. The embodiment also includes a channel 104a for cooling. In this embodiment, the modular coil is formed of six parts, an outer left wall 606a, a middle left wall 604a, and an inner left wall 602a, which are located on the cavity 612 side (receiving or first portion 600a); and an outer right wall 606b, a middle right wall 604b, and an inner right wall 602b which are on the connecting seam 610 side (connecting or second portion 600b). The modular coil from the second embodiment may be joined to form a single coil structure as shown in FIG. 6B. This singular coil structure may then be coupled, preferably connected, to other similar coil structures and form an assembly that may describe a magnetic chamber. For example, they could be used to construct the dome 400 from FIG. 4.

The inner wall may be called the “first wall”, the middle wall may be called the “second wall”, and the outer wall may be called the “third wall”.

FIG. 6C shows an exploded view of a modular coil according to the second embodiment. Each of the wall parts form a continuing structure and it is therefore possible to construct them with different characteristics. For example, the inner wall pair formed of walls 602a and 602b may have a different current defining pattern than the ones in the middle wall, formed of walls 604a and 604b, and the outer wall sections, formed of walls 606a and 606b.

The inner wall 602a, 602b of each side may include layer 300 of FIG. 3, the middle wall 604a, 604b of each side may include layers 301, 302, 303, 304, possibly 305 and/or 308, the groove 110a and layer 306 of FIG. 3, and the outer wall 606a, 606b of each side may include layer 310 of FIG. 3.

Example embodiments of the invention are summarized here. Other embodiments can also be understood from the entirety of the specification as well as the claims filed herein.

Example 1. An assembly comprising a plurality of modular coils (100a, 100b; 401) mechanically and electrically joined together, wherein each modular coil comprises a groove (110a, 110b) separating the modular coil into at least two different electrically conducting regions.

Example 2. The assembly according to example 1, wherein the plurality of modular coils comprises at least a first modular coil (100a) having a first groove (110a) and a second modular coil (100b) joined to the first modular coil and having a second groove (110b), wherein the first and second grooves are adapted to form a continuing groove (110; 210) separating the joined first and second modular coils into at least two different electrically conducting regions.

Example 3. The assembly according to example 1 or 2, wherein the grooves (110a, 110b, 110; 210) are adapted to guide a flow of current in a certain direction through the joined modular coils, in order to create a magnetic field (202a; 202b; 500) that is at least partially confined in the assembly.

Example 4. The assembly according to any of examples 1 to 3, wherein the shape of the groove (110a, 110b, 110; 210) of at least one of the modular coils determines the electrical current configuration to pass through said modular coil, and therefore, the shape of the magnetic field (202a; 202b) that is formed when the current flows.

Example 5. The assembly according to any of examples 1 to 4, wherein the groove (110a, 110b, 110; 210) of at least one of the modular coils contains a metal, for example silver.

Example 6. The assembly according to any one of examples 1 to 5, wherein the plurality of modular coils comprises a first modular coil (100a) having a first joining mechanism (102a), like a flange, and a second modular coil (100b) having a second joining mechanism (102b), like a flange, adapted to be coupled, preferably connected, to the first joining mechanism (102a).

Example 7. The assembly according to example 6, wherein each joining mechanism is also adapted to provide for electrical connection between the first and second modular coils.

Example 8. The assembly according to any one of examples 1 to 7, wherein at least one of the modular coils (100a, 100b; 401) comprises a channel (104a, 104b), for example to enable a cooling fluid, like nitrogen or helium, to flow through said modular coil.

Example 9. The assembly according to example 8, wherein the plurality of modular coils comprises a first modular coil (100a) having a first channel (104a) and a second modular coil (100b) joined to the first modular coil and having a second channel (104b) adapted to be joined to the first channel (104a) to form a single channel that crosses the joined first and second modular coils.

Example 10. The assembly according to any one of examples 1 to 9, wherein at least one of the modular coils is constructed to exhibit superconducting characteristics.

Example 11. The assembly according to any one of examples 1 to 10, wherein at least one of the modular coils is constructed as a stacking of different materials, comprising at least a superconducting layer (304) comprising a superconducting material, like yttrium barium copper oxide or rare-earth barium copper oxide, wherein the groove (110a) of said modular coil is patterned at least in the superconducting layer.

Example 12. The assembly according to example 11, wherein the stacking comprises:
a structural layer (300), for example composed or covered by a material like Hastelloy;
a plurality of buffer layers on the structural layer;
the superconducting layer (304) on the plurality of buffer layers; and
a shunt layer (306) on the superconducting layer (304) and in the groove (110a), the shunt layer being made of a metal, for example silver;
   wherein the groove is patterned in the buffer layers and the superconducting layer.

Example 13. The assembly according to example 12, wherein the plurality of buffer layers comprises:
a first buffer layer (301) on the structural layer (300), for example a layer of a material like alumina;
a second buffer layer (302) on the first buffer layer (301), for example a layer of a material like yttria;
a third buffer layer (303) on the second buffer layer (302), for example a layer of a material like magnesium oxide.

Example 14. The assembly according to any one of examples 11 to 13, wherein the stacking comprises a silver layer (305) on the superconducting layer (304).

Example 15. The assembly according to any one of examples 12 or 14, wherein the stacking comprises a repeater layer (308) under the shunt layer (306), the repeater layer being made of the repetition of the buffer and superconducting layers, and in some cases of the silver layer, preferably several repetitions, for example between 4 and 80 repetitions, wherein the groove is patterned in the buffer layers, the superconducting layer and the repeater layer.

Example 16. The assembly according to any one of examples 12 to 15, wherein the stacking comprises another superconducting layer (310), preferably a non-perforated and non-grooved layer, on the shunt layer (306), comprising for example a superconducting material like yttrium barium copper oxide or rare-earth barium copper oxide.

Example 17. The assembly according to any one of examples 11 to 16 in combination with example 8 or 9, wherein the channel (104a) of the at least one modular coil goes through the structural layer (300).

Example 18. The assembly according to any one of examples 1 to 17, wherein at least one of the modular coils comprises a first portion (600a) and a second portion (600b), the first and second portions being adapted to be coupled together, for example the first portion comprising a connecting seam (610) and the second portion comprising a receiving cavity (612) adapted to engage the connecting seam.

Example 19. The assembly to any one of examples 1 to 18, wherein at least one of the modular coils, and for example each of the first and second portions of said modular coil, is formed of at least two walls assembled together, for example two or three walls.

Example 20. The assembly according to example 19 in combination with example 18, wherein each of the first and second portions is formed of a first wall (602a, 602b), a second wall (604a, 604b), and a third wall (606a, 606b), the second wall being between the first wall and the third wall; and wherein the first wall (602a) of the first portion (600a) is adapted to form a continuing first wall pair with the first wall (602b) of the second portion (600b), the second wall (604a) of the first portion (600a) is adapted to form a continuing second wall pair with the second wall (604b) of the second portion (600b), and the third wall (606a) of the first portion (600a) is adapted to form a continuing third wall pair with the third wall (606b) of the second portion (600b), for example one of the wall pairs having a different current defining pattern than another wall pair.

Example 21. The assembly according to any one of examples 1 to 20, wherein the modular coils (401) form a magnetic chamber (400).

Example 22. A modular coil (100a, 100b) adapted to an assembly according to any one of examples 1 to 21.

Example 23. A method for fabricating a modular coil (100a, 100b) according to example 22, the method comprising:
providing a structural layer (300);
forming a plurality of buffer layers on the structural layer;
depositing, for example by metal-organic chemical vapor deposition, a superconducting layer (304) on the plurality of buffer layers;
removing material at least from the superconducting layer, for example using a laser patterning technique, to form a groove (110a); and
depositing a layer of a metal on the superconducting layer, comprising filling the groove with said metal, for example silver, to form a shunt layer (306).

Example 24. The method according to example 23, further comprising:
forming a silver layer (305) on the superconducting layer (304).

Example 25. The method according to example 23 or 24, further comprising:
repeating the buffer layers, the superconducting layer, and in some cases the silver layer, before forming the groove and forming the shunt layer (306), preferably several times, for example between 4 and 80 repetitions.

Example 26. The method according to any one of examples 23 to 25, wherein forming the plurality of buffer layers comprises:
sputtering a first buffer layer (301) on the structural layer (300), for example a layer of a material like alumina;
sputtering a second buffer layer (302) on the first buffer layer (301), for example a layer of a material like yttria;
depositing, for example by metal-organic chemical vapor deposition or ion beam assisted deposition, a third buffer layer (303) on the second buffer layer (302), for example a layer of a material like magnesium oxide.

Example 27. The method according to any one of examples 22 to 26, further comprising:
depositing another superconducting layer (310), preferably a non-perforated and non-grooved layer, on the shunt layer (306), comprising for example a superconducting material like yttrium barium copper oxide or rare-earth barium copper oxide.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

List of acronyms:
MRI Magnetic Resonance Imaging
MOCVD Metal-organic chemical vapor deposition
IBAD Ion beam assisted deposition
REBCO Rare-earth barium copper oxide
YBCO Yttrium barium copper oxide

1. An assembly comprising a plurality of modular coils mechanically and electrically joined together, wherein each modular coil comprises a groove separating the modular coil into at least two different electrically conducting regions; wherein at least one of the modular coils is constructed to exhibit superconducting characteristics, and is constructed as a stacking of different materials comprising at least a superconducting layer comprising a superconducting material, wherein the groove of said modular coil is patterned at least in the superconducting layer.

2. The assembly according to claim 1, wherein the plurality of modular coils comprises at least a first modular coil having a first groove and a second modular coil joined to the first modular coil and having a second groove, wherein the first and second grooves are adapted to form a continuing groove separating the joined first and second modular coils into at least two different electrically conducting regions.

3. The assembly according to claim 1, wherein the grooves are adapted to guide a flow of current in a certain direction through the joined modular coils, in order to create a magnetic field that is at least partially confined in the assembly.

4. The assembly according to claim 1, wherein the shape of the groove of at least one of the modular coils determines the electrical current configuration to pass through said modular coil, and therefore, the shape of the magnetic field that is formed when the current flows.

5. The assembly according to claim 1, wherein the groove of at least one of the modular coils contains a metal, for example silver.

6. The assembly according to claim 1, wherein the plurality of modular coils comprises a first modular coil having a first joining mechanism, like a flange, and a second modular coil having a second joining mechanism, like a flange, adapted to be coupled, preferably connected, to the first joining mechanism.

7. The assembly according to claim 6, wherein each joining mechanism is also adapted to provide for electrical connection between the first and second modular coils.

8. The assembly according to claim 1, wherein at least one of the modular coils comprises a channel, for example to enable a cooling fluid, like nitrogen or helium, to flow through said modular coil.

9. The assembly according to claim 8, wherein the plurality of modular coils comprises a first modular coil having a first channel and a second modular coil joined to the first modular coil and having a second channel adapted to be joined to the first channel to form a single channel that crosses the joined first and second modular coils.

10. The assembly according to claim 1, wherein the superconducting material is a yttrium barium copper oxide or a rare-earth barium copper oxide.

11. The assembly according to claim 1, wherein the stacking comprises:
a structural layer, for example composed or covered by a material like Hastelloy;
a plurality of buffer layers on the structural layer;
the superconducting layer on the plurality of buffer layers;
wherein the groove is patterned in the buffer layers and the superconducting layer.

12. The assembly according to claim 1, wherein the stacking comprises a silver layer on the superconducting layer.

13. The assembly according to claim 11, wherein the stacking further comprises:
a shunt layer on the superconducting layer and in the groove, the shunt layer being made of a metal, for example silver.

14. The assembly according to claim 13, wherein the stacking comprises a repeater layer under the shunt layer, the repeater layer being made of the repetition of the buffer and superconducting layers, and in some cases of the silver layer, preferably several repetitions, for example between 4 and 80 repetitions, wherein the groove is patterned in the buffer layers, the superconducting layer and the repeater layer.

15. The assembly according to claim 13, wherein the stacking comprises another superconducting layer, preferably a non-perforated and non-grooved layer, on the shunt layer, the other superconducting layer comprising for example a superconducting material, like yttrium barium copper oxide or rare-earth barium copper oxide.

16. The assembly according to claim 11, wherein the channel of the at least one modular coil goes through the structural layer.

17. The assembly according to claim 1, wherein at least one of the modular coils comprises a first portion and a second portion, the first and second portions being adapted to be coupled together, for example the first portion comprising a connecting seam and the second portion comprising a receiving cavity adapted to engage the connecting seam.

18. The assembly according to claim 1, wherein at least one of the modular coils, and for example each of the first and second portions of said modular coil, is formed of at least two walls assembled together, for example two or three walls.

19. The assembly according to claim 1, wherein the modular coils form a magnetic chamber.

20. A modular coil adapted to an assembly according to claim 1.
